(19) United States
(12) Patent Application Publication
(10) Pub. No.: US 2010/0250800 A1
(43) Pub. Date: Sep. 30, 2010

(54) INPUT DEVICE

(76) Inventor: Wei-Chen Lee, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/731,129

(22) Filed: Mar. 24, 2010

(30) Foreign Application Priority Data
Mar. 26, 2009 (TW) 098109921

(51) Int. Cl. G06F 13/38; G06F 13/40

(52) U.S. Cl. 710/63; 710/306

(57) ABSTRACT

An input device is provided. The input device in the invention for connecting a first data processing apparatus and a second data processing apparatus includes a first connecting module, a bridging unit, and a second connecting module. The first connecting module is connected with the first data processing apparatus. The bridging unit is connected with the first connecting module. The second connecting module is connected with the bridging unit and the second data processing apparatus. Thus, the first data processing apparatus and the second data processing apparatus transfer a file therebetween via the first connecting module, the bridging unit, and the second connecting module.

### CROSS-REFERENCE TO RELATED APPLICATIONS

This Non-provisional application claims priority under 35 U.S.C. §119(a) on Patent Application No(s). 098109921 filed in Taiwan, Republic of China on Mar. 26, 2009, the entire contents of which are hereby incorporated by reference.

### BACKGROUND OF THE INVENTION

1. Field of the Invention

This invention relates to an input device and, more particularly, to an input device capable of connecting a first data processing apparatus and a second data processing apparatus to transfer a file therebetween.

2. Description of the Related Art

In early periods, when data are transferred or backed up between two computers, printer ports of the two computers are connected with each other via a transmitting cable, such that the data in one of the two computers can be transferred to the other computer. Since a universal serial bus (USB) integrates many connecting ports with specific specifications and provides a stabler and faster transmitting environment, the transmitting cable having printer plugs have been gradually eliminated. Therefore, at present, it is hard for a user to transfer or back up the data via the printer ports.

The USB interface specification has the advantages of plug-and-play (PNP), connecting 127 USB devices in series at most, providing 5V power, and only occupying one interrupt request (IRQ). Almost all the current computers support the USB interface specification. Further, the USB 2.0 specification has been developed recently, such that the transferring rate of the USB interface has improved to 480 Mbps. Because of the convenience and the high transferring rate of the USB interface, the USB interface is used to more and more peripheral apparatus of the computers and other information products.

Further, a USB transmitting cable capable of transferring data between two computers has been introduced. Please refer to FIG. 1. FIG. 1 is a functional block diagram showing a USB transmitting cable capable of transferring data between two computers in the prior art.

In FIG. 1, a USB transmitting cable 7 includes a first connector 70, a first connecting cable 72, a second connector 74, a second connecting cable 76, and a bridging chip 78. The first connector 70 is connected with the bridging chip 78 by the first connecting cable 72, and the second connector 74 is connected with the bridging chip 78 by the second connecting cable 76.

Further, the first connector 70 may be connected with a first controller 900 of a first computer 90, and the second connector 74 may be connected with a second controller 920 of a second computer 92. Thus, the controllers 900, 920 of the two computers 90, 92 provide a host function, and the bridging chip 78 provides a device function, such that the two computers 90, 92 can transfer data therebetween in the master/slave system of a USB interface.

### BRIEF SUMMARY OF THE INVENTION

One objective of this invention is to provide an input device capable of connecting two data processing apparatus to transfer or back up a file therebetween.

In one embodiment of the invention, an input device for connecting a first data processing apparatus and a second data processing apparatus includes a first connecting module, a bridging unit, and a second connecting module. The first connecting module is connected with the first data processing apparatus. The bridging unit is connected with the first connecting module. The second connecting module is connected with the bridging unit and the second data processing apparatus. Thus, the first data processing apparatus and the second data processing apparatus transfer a file via the first connecting module, the bridging unit, and the second connecting module.

In the embodiment, the input device may further include a controlling unit connected with the bridging unit. Particularly, when the first data processing apparatus and the second data processing apparatus transfer the file therebetween, the controlling unit may encrypt the file.

To sum up, the input device according the invention may connect the two data processing apparatus at the same time for transferring the file therebetween. Thus, a user may transfer or back up the file between the two data processing apparatus without additionally buying or carrying a transmitting cable. In addition, the input device according the invention may automatically back up the file of the data processing apparatus and encrypt the backup file, thus to prevent the data from failing to be recovered after being damaged by external factors.

These and other features, aspects, and advantages of the present invention will become better understood with regard to the following description, appended claims, and accompanying drawings.

### BRIEF DESCRIPTION OF THE DRAWINGS

FIG. 1 is a functional block diagram showing a USB transmitting cable capable of transferring data between two computers in the prior art;

FIG. 2 is a functional block diagram showing a mouse connected with a notebook computer according to one embodiment of the invention;

FIG. 3 is a schematic diagram showing the mouse in FIG. 2;

FIG. 4 is a schematic diagram showing the mouse connected with the notebook computer in FIG. 2;

FIG. 5 is a functional block diagram showing a mouse connected with a notebook computer according to one embodiment of the invention;

FIG. 6 is a functional block diagram showing a keyboard according to one embodiment of the invention; and

FIG. 7 is a schematic diagram showing the keyboard in FIG. 6.

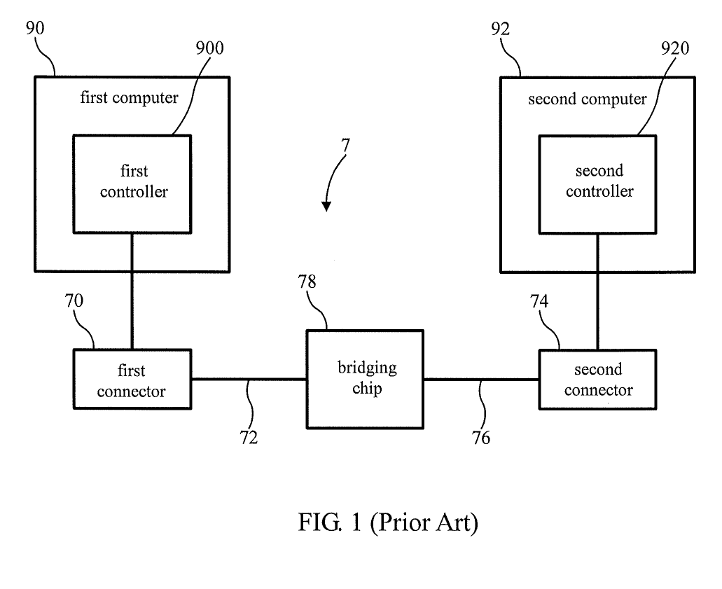

### DETAILED DESCRIPTION OF THE INVENTION

This invention provides an input device for connecting two data processing apparatus to transfer or back up a file therebetween. A plurality of embodiments according to the invention are described hereinbelow.

The input device in the embodiment of the invention may be a mouse, a keyboard and so on. However, the invention is not limited thereto. In addition, the data processing apparatus in the embodiment of the invention may be a desktop computer, a notebook computer, a tablet computer and so on. However, the invention is not limited thereto.

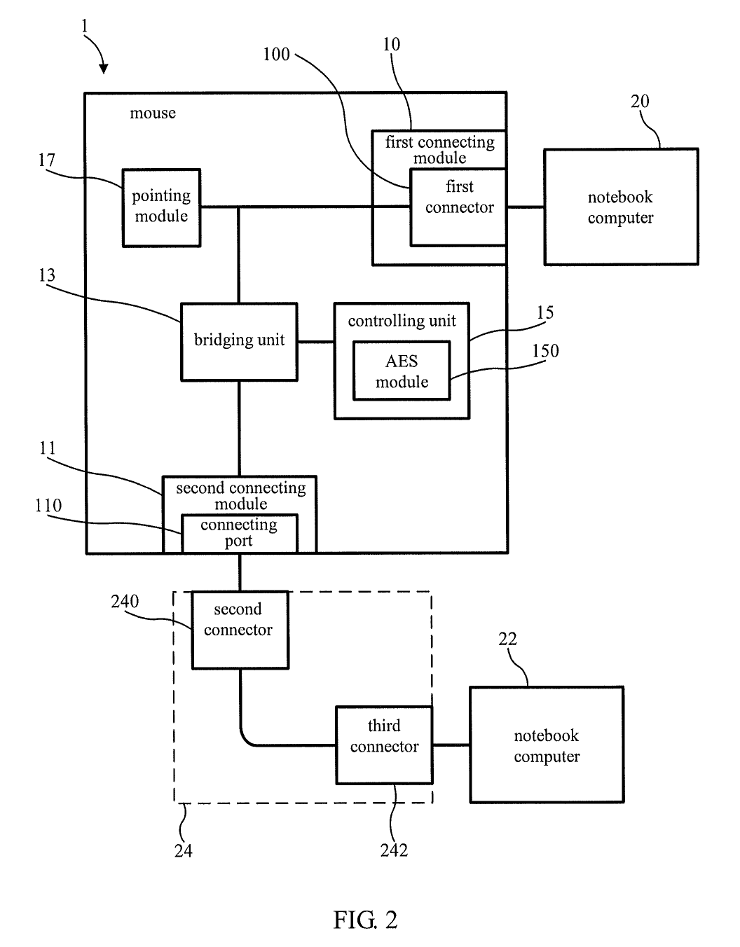

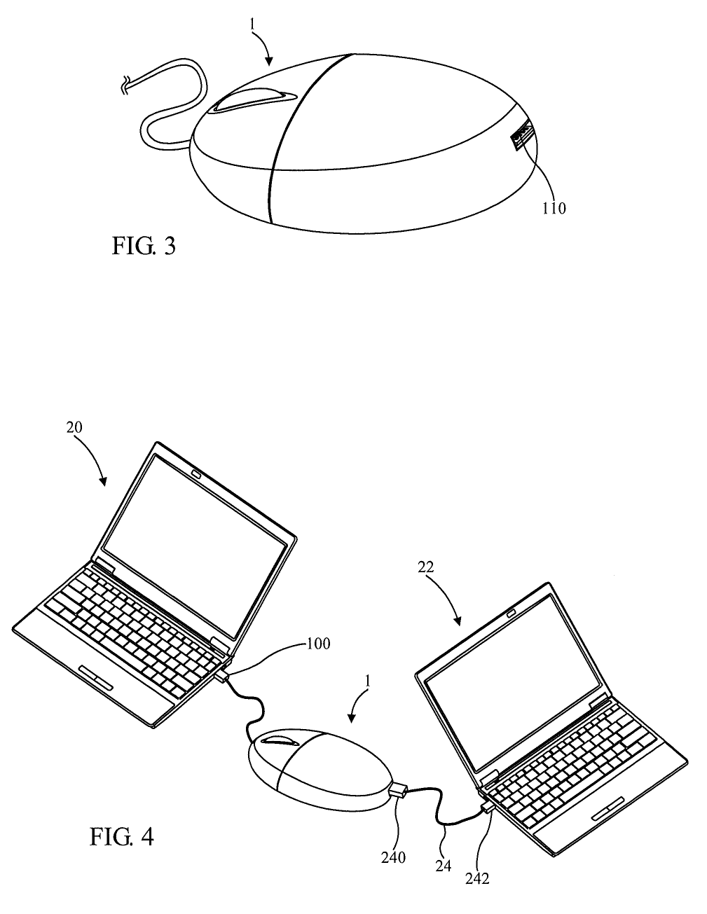

A mouse as the input device is taken for example in one embodiment of the invention, and a notebook computer as the data processing apparatus is taken for example in one embodiment of the invention hereinbelow. Please refer to FIG. 2 to FIG. 4. FIG. 2 is a functional block diagram showing a mouse 1 connected with notebook computers 20, 22. FIG. 3 is a schematic diagram showing the mouse 1. FIG. 4 is a schematic diagram showing the mouse 1 connected with the notebook computers 20, 22.

In FIG. 2, the mouse 1 includes a first connecting module 10, a second connecting module 11, a bridging unit 13, a controlling unit 15, and a pointing module 17.

In the embodiment, the first connecting module 10 has a first connector 100 pluggably connected with the notebook computer 20. The first connecting module 10 may include a universal serial bus (USB) hub, and the first connector 100 may be a USB connector. Certainly, according to different conditions, the interface of the USB connector may be designed to be a mini-USB interface, a micro-USB interface and so on. In addition, in an actual application, the first connecting module 10 may be a hub in other types, and the first connector 100 may also correspondingly be a connector in other types.

In the embodiment, the second connecting module 11 includes a connecting port 110 for pluggably connecting a second connector 240 of a connecting cable 24. The connecting cable 24 further includes a third connector 242 pluggably connected with the notebook computer 22. As described above, the connecting port 110 can be a USB connecting port, and the connectors 240, 242 of the connecting cable 24 can be USB connectors. The connecting port 110 may be a connecting port in other types, and the connectors 240, 242 may correspondingly be connectors in other types.

The bridging unit 13 is connected with the first connecting module 10 and the second connecting module 11. Thus, a user may transfer or back up a file stored in the notebook computer 20 to the notebook computer 22 via the first connecting module 10, the bridging unit 13, and the second connecting module 11. The user also may transfer or back up a file stored in the notebook computer 22 to the notebook computer 20 via the second connecting module 11, the bridging unit 13, and the first connecting module 10.

The controlling unit 15 is connected with the bridging unit 13. When the notebook computer 20 and the notebook computer 22 transfer the file therebetween, the controlling unit 15 encrypts the transferred file, thus to ensure the security of the file. For example, the controlling unit 15 may include an advanced encryption standard (AES) module 150 as shown in FIG. 2 for encrypting the file.

In the embodiment, the input device may further include a storing unit (not shown) for storing the file transferred between the notebook computer 20 and 22 or data needed by the operation of each unit and module of the mouse 1. For example, the storing unit may be a built-in memory or an external memory card.

In addition, since the input device in the embodiment is the mouse 1, the mouse 1 includes the pointing module 17 and other elements, such as buttons, a scroll and so on, thus to allow the mouse 1 to have an original control function.

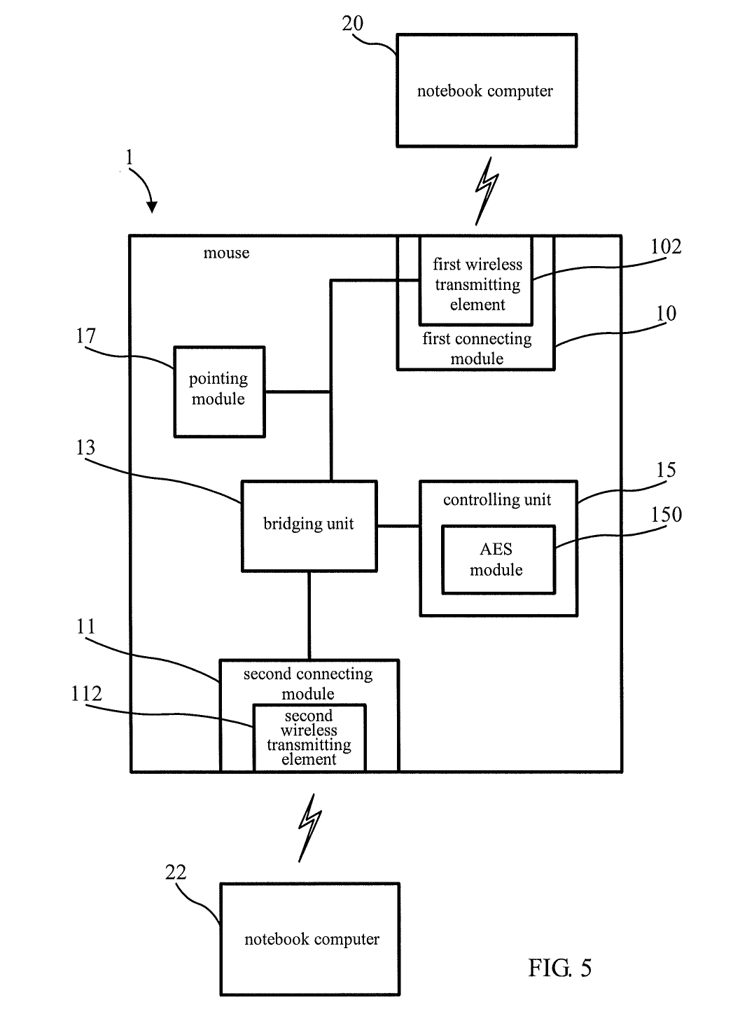

Please refer to FIG. 5. FIG. 5 is a functional block diagram showing a mouse 1 connected with notebook computers 20, 22 according to another embodiment of the invention. The difference between this embodiment and the above embodiment is that a first connecting module 10 of the mouse 1 in this embodiment includes a first wireless transmitting element 102, and a second connecting module 11 includes a second wireless transmitting element 112. Thus, the first connecting module 10 and the second connecting module 11 can be connected with the notebook computers 20, 22 in a wireless mode, respectively. In an actual application, the wireless transmitting elements 102, 112 may be Bluetooth transmitting elements or transmitting elements in other proper types.

In the embodiment, the mouse 1 also includes a bridging unit 13, a controlling unit 15, and a pointing module 17 as described above. Further, functions and connections thereof are the same as that described above. Therefore, they are not described herein for a concise purpose.

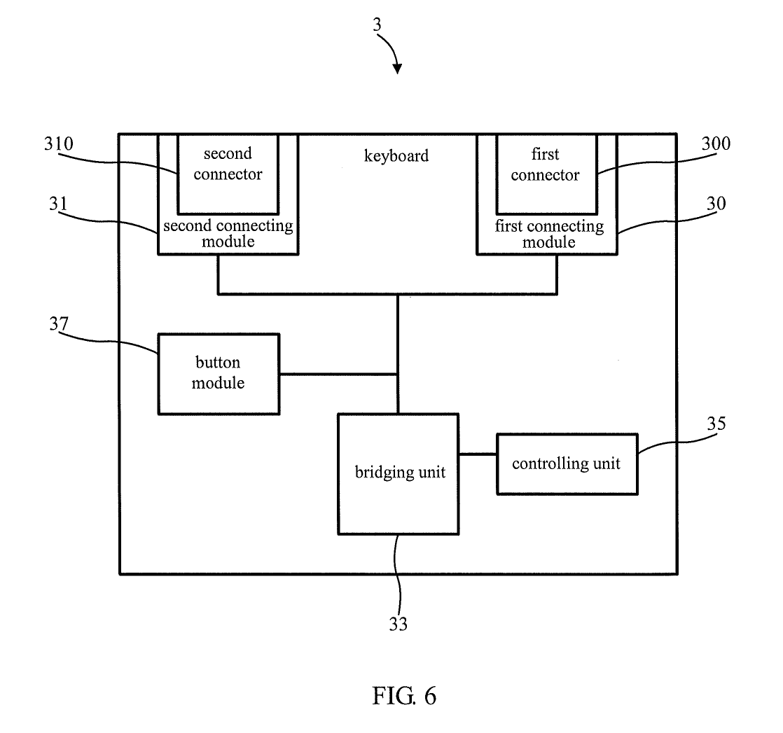

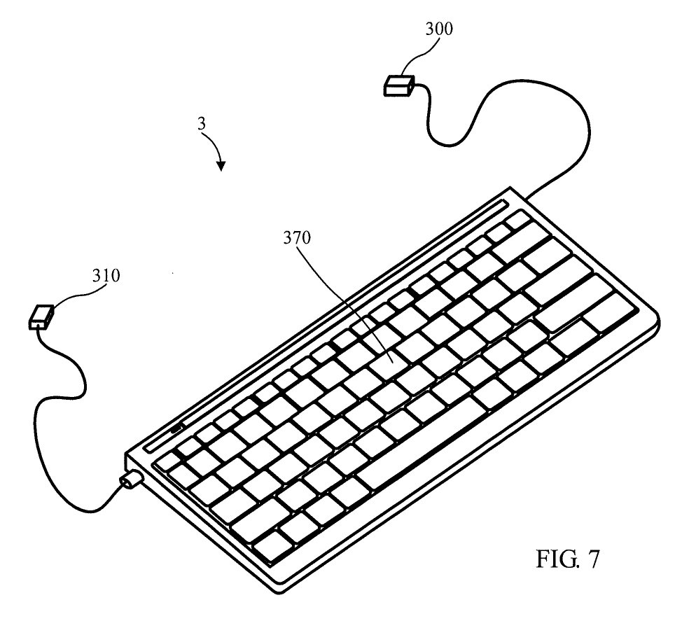

A keyboard as the input device is taken for example in another embodiment of the invention. Please refer to FIG. 6 and FIG. 7 together. FIG. 6 is a functional block diagram showing a keyboard 3. FIG. 7 is a schematic diagram showing the keyboard 3.

In FIG. 6, the keyboard 3 includes a first connecting module 30, a second connecting module 31, a bridging unit 33, a controlling unit 35, and a button module 37.

In the embodiment, the first connecting module 30 has a first connector 300 pluggably connected with a first data processing apparatus (not shown). Further, the second connecting module 31 has a second connector 310 pluggably connected with a second data processing apparatus (not shown). The bridging unit 33 is connected with the first connecting module 30 and the second connecting module 31.

In addition, the button module 37 includes a plurality of buttons 370 to allow the user to input data into the first data processing apparatus or the second data processing apparatus. In the embodiment, connections and functions of the controlling unit 35 and other units are the same as that described above. Therefore, they are not described herein for a concise purpose.

In the embodiment, the first connecting module and the second connecting module of the input device may include a connector, a connecting port, or a wireless transmitting element as described above according to different conditions. Further, in an actual application, the bottom of the input device, such as the mouse 1 or the keyboard 3, may have a containing space for containing space containing the first connecting module, the second connecting module, the connecting cable, or the combination thereof.

To sum up, the input device in the embodiment of the invention can connect two data processing apparatus at the same time for transferring the file therebetween. Thus, the user can transfer or back up the file between the two data processing apparatus without additionally buying or carrying a transmitting cable. In addition, the input device can further automatically back up the file of the data processing apparatus and encrypt the backup file, thus to prevent the data from failing to be recovered after being damaged by external factors.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An input device for connecting a first data processing apparatus and a second data processing apparatus, the input device comprising:
a first connecting module connected with the first data processing apparatus;
a bridging unit connected with the first connecting module; and
a second connecting module connected with the bridging unit and the second data processing apparatus,
wherein the first data processing apparatus and the second data processing apparatus transfer a file via the first connecting module, the bridging unit, and the second connecting module.

2. The input device according to claim 1, wherein the first connecting module has a first connector pluggably connected with the first data processing apparatus.

3. The input device according to claim 2, wherein the first connecting module comprises a universal serial bus (USB) hub, and the first connector is a USB connector.

4. The input device according to claim 2, wherein the second connecting module has a second connector pluggably connected with the second data processing apparatus.

5. The input device according to claim 4, wherein the second connecting module comprises a USB hub, and the second connector is a USB connector.

6. The input device according to claim 2, wherein the second connecting module comprises a connecting port for pluggably connecting a second connector of a connecting cable, and the connecting cable includes a third connector pluggably connected with the second data processing apparatus.

7. The input device according to claim 6, wherein the second connecting module comprises a USB hub, and the second connector and the third connector are a USB connector, respectively.

8. The input device according to claim 2, wherein the second connecting module comprises a wireless transmitting element.

9. The input device according to claim 8, wherein the wireless transmitting element is a Bluetooth transmitting element.

10. The input device according to claim 1, further comprising:
a controlling unit connected with the bridging unit, wherein when the first data processing apparatus and the second data processing apparatus transfer the file therebetween, the controlling unit encrypts the file.

11. The input device according to claim 10, wherein the controlling unit comprises an advanced encryption standard (AES) module for encrypting the file.

12. The input device according to claim 1, further comprising a pointing module.

13. The input device according to claim 1, further comprising a button module.

14. The input device according to claim 1, wherein the first data processing apparatus and the second data processing apparatus are selected from the group consisting of a desktop computer, a notebook computer, and a tablet computer, respectively.
